(19) United States
(12) Patent Application Publication
(10) Pub. No.: US 2014/0229508 A1
(43) Pub. Date: Aug. 14, 2014

(54) SYSTEM AND METHOD FOR ENABLING USERS TO SELECT COMBINATION OF NUMERIC OR ALPHA NUMERIC CHARACTERS

(71) Applicant: Adarsh JAIN, New Delhi (IN)

(72) Inventor: Adarsh JAIN, New Delhi (IN)

(21) Appl. No.: 14/171,789

(22) Filed: Feb. 4, 2014

(30) Foreign Application Priority Data
Feb. 12, 2013 (IN) 400/DEL/2013

(51) Int. Cl. G06F 21/62; G06F 17/30

(52) U.S. Cl. CPC G06F 21/6227; G06F 17/30893
USPC 707/785

(57) ABSTRACT

A system for enabling users to select combination of characters includes a database, a system restriction module, a rule engine and processing module. The database comprises a list of combinations of characters. The system restriction module comprises instructions to select combinations of characters present in the database, based on input received from a user. The rule engine comprises instructions to add combinations of characters to the characters selected from the database, based on input received from the user. The processing module is configured to apply the input to query the system restriction module and fetch corresponding instructions; apply the input to query the rule engine and fetch corresponding instructions; query the database based on the instructions fetched from the system restriction module; generate complete combinations of characters based on the instructions fetched from the rule engine; and communicate generated complete combinations of characters to the user.

### BACKGROUND

1. Field

The disclosed subject matter relates to the field of computing, and more particularly but not exclusively to providing a choice of numeric or alpha numeric characters to users, which can be chosen as telephone number.

2. Discussion of Related Field

In several scenarios, users have an option to choose numeric or alphanumeric characters, which may be assigned to one of their belongings. For example, when a user has to pick a telephone number, a telecom service provider manually provides a list of telephone numbers to choose from. The list generally includes a few telephone numbers among several telephone numbers that are available for selection. The user then manually screens through the list provided to him and picks a number that the user likes.

In case the user has certain preferences, such as, presence of his birth date in the telephone number, the telecom service provider will have to manually screen through all the available telephone numbers to present such options. Further, there could be several such telephone numbers that may match the user's preference, which may not be identified by following the conventional approach. Furthermore, if a telephone number matches one or more parameters requested to be matched by the user, has been assigned to a different user, then such a number is not even presented as a choice to the user.

In the field of automobiles as well, users face similar difficulties as hereinabove highlighted, while selecting alpha numeric characters as registration number of their automobiles.

In light of the foregoing discussion, there is a need for a more efficient technique to enable users to select numeric or alpha numeric characters.

### SUMMARY

Accordingly the invention provides a system for enabling users to select combination of characters. The system comprising a database comprising a list of combinations of characters. The system further comprises a system restriction module comprising instructions to select one or more combinations of characters present in the database, based on at least a part of input received from a user. The system further comprises a rule engine comprising instructions to add combinations of characters to the one or more combinations of characters selected from the database, based on at least a part of input received from the user. The system further comprises a processing module configured to: apply at least a part of the input received from the user to query the system restriction module and fetch corresponding instructions from the system restriction module; apply at least a part of the input received from the user to query the rule engine and fetch corresponding instructions from the rule engine; query the database based on the instructions fetched from the system restriction module; generate complete combinations of characters based on the instructions fetched from the rule engine; and communicate one or more generated complete combinations of characters to the user.

### BRIEF DESCRIPTION OF DRAWINGS

Embodiments are illustrated by way of example and not limitation in the Figures of the accompanying drawings, in which like references indicate similar elements and in which:

FIG. 1 is an example block diagram of a system 100 for enabling users to select combination of numeric or alpha numeric characters, in accordance with an embodiment;

FIG. 2 is an example illustration of the system 100 communicating with external devices, in accordance with an embodiment;

FIG. 3 is an example flow chart of a method for enabling users to select combination of numeric or alpha numeric characters, in accordance with an embodiment;

FIGS. 4 and 5 illustrate user interface to receive input from the user, wherein the system 100 is used to enable the user to select phone numbers, in accordance with an embodiment; and

FIG. 6 illustrates a user interface displaying a list of phone numbers, which the user can choose from, in accordance with an embodiment.

### DETAILED DESCRIPTION

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments. The embodiments can be combined, other embodiments can be utilized, or structural, logical and electrical changes can be made without departing from the scope of what is claimed. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

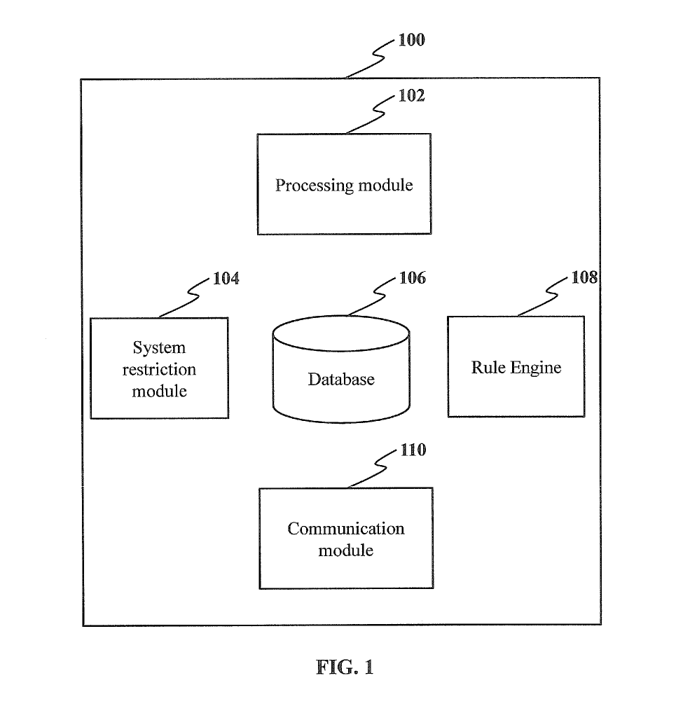

Embodiments disclose technique for enabling users to select combination of numeric or alpha numeric characters, wherein FIG. 1 is an example block diagram of a system 100 for enabling users to select combination of numeric or alpha numeric characters, in accordance with an embodiment. The system 100 includes a processing module 102, a system restriction module 104, a database 106, a rule engine 108 and a communication module 110.

In an embodiment, the database 106 includes a list of numeric characters combinations or a list of alpha numeric character combinations, based on the field of application.

In an embodiment, the combinations present in the database 106 are a list of numeric or alpha numeric character series, which can eventually form a part of combinations of numeric or alpha numeric characters that a user can choose.

In another embodiment, wherein the system 100 is used in the field of telecommunication, the database 106 includes a list of phone number series, which would be part of phone numbers that a user can choose from.

Further, each phone number series will correspond to a respective telecom service provider. Additionally, each phone number series will correspond to a jurisdiction.

In an embodiment, the database 106 is made available within the same computing environment as the rest of the elements of the system 100.

In another embodiment, the database 106 is at a remote location with respect to the rest of the elements of the system 100.

In an embodiment, the system restriction module 104 is configured to include criteria for selecting one or more combinations of alpha numeric or numeric characters present in the database 106.

In an embodiment, the system restriction module 104 includes a criteria, such as, based on the jurisdiction of the user, only corresponding series can be selected for further processing. Further, based on the preference of the user for certain telecom service providers, only those series corresponding to the said telecom service providers can be selected for further processing.

For example, when the system 100 is used in the field of telecommunication, the system restriction module 104 can include criteria, such as, if the location of the user is Delhi, then the first five digits of the phone numbers that are selected for further processing should be selected from a predefined series of numbers.

In an embodiment, the rule engine 108 defines rules to generate combinations of numeric or alpha numeric characters, which the user can choose from, based on the input provided by the user.

For example, when the system 100 is applied to the field of telecommunication, the user may instruct the system to generate a list of phone numbers, from which he can select one or more phone numbers, based on astrology. The rule engine 108 includes instructions corresponding to the rules to be applied to generate combination of phone numbers based on astrology.

In an embodiment, users are presented with options on a user interface to specify criteria.

In an embodiment, the processing module 102 is configured to apply at least a part of the input received from the user to query the system restriction module 104, and fetch corresponding instructions from the system restriction module 104. Likewise, the processing module is configured to apply at least a part of the input received from the user to query the rule engine 108, and fetch corresponding instructions from the rule engine 108.

In an embodiment, the processing module 102 is configured to query the database 106 based on the instructions fetched from the system restriction module 104.

In another embodiment, the processing module 102 is configured to query the database 106 based on the instructions fetched from the system restriction module 104 and the rule engine 108.

The processing module 102 is further configured to generate the complete combinations of numeric or alpha numeric characters based on the instructions fetched from the rule engine 108.

For example, if the system 100 is used in the field of telecommunication, the processing module 102 retrieves suitable telephone number series from the database 106. Thereafter, the processing module 102 constructs telephone number combinations using the instructions fetched from the rule engine 108.

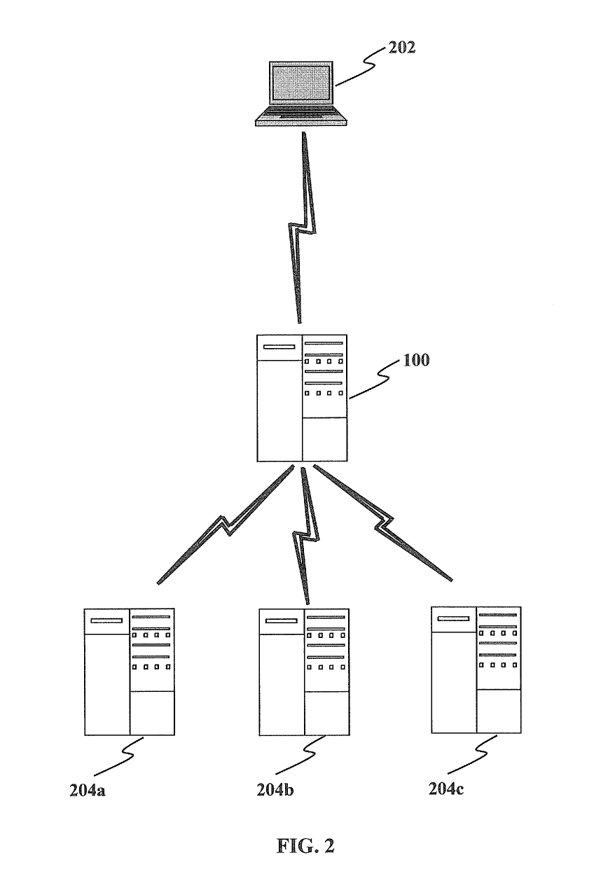

Once, the telephone numbers are constructed, the telephone numbers are validated. The communication module 110, communicates with one or more external devices, such as servers, to validate the telephone numbers. FIG. 2 is an example illustration of the system 100 communicating with external devices, in accordance with an embodiment. In the instant figure, system 100 is communicating with the user's data processing system 202 and servers 204a, 204b and 204c. The servers 204 may belong to telecom service providers.

In an embodiment, the communication module 110 communicates the generated telephone numbers with respective servers 204 to identify the status of the telephone numbers.

In an embodiment, the status of each telephone number may be either available for allocation or already allotted. The status update received from the respective servers 204 is communicated to the processing module 102.

In an embodiment, only those telephone numbers that are available for allocation are communicated to the user through the communication module 110.

In another embodiment, the telephone numbers generated by the processing module 102 are communicated to the user along with the information corresponding to the status.

In an embodiment, the telephone numbers communicated to the user is ranked by the processing module 102 based on the instructions fetched from the rule engine 108.

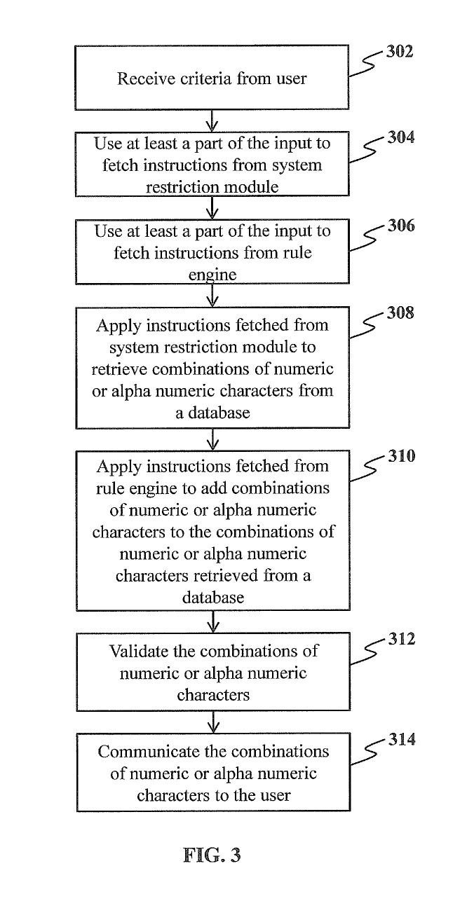

FIG. 3 is an example flow chart of a method for enabling users to select combination of numeric or alpha numeric characters, in accordance with an embodiment. At step 302, user input is received by the system 100. The user input, for example, can include the user's jurisdiction, preference for one or more service providers and date of birth. At step 304, at least a part of the input is used to fetch instructions from the system restriction module 104. For example, information corresponding to the user's jurisdiction and his preference for one or more service providers is used to fetch corresponding instructions from the system restriction module 104. At step 306, at least a part of the input is used to fetch instructions from the rule engine 108. For example, information corresponding to the user's date of birth is used to fetch corresponding instructions from the rule engine 108 to generate combinations based on astrology. At step 308, instructions fetched from the system restriction module 104 is applied to retrieve combinations of numeric or alpha numeric characters from the database 106. Further, at step 310, instructions fetched from the rule engine 108 is applied to add combinations of numeric or alpha numeric characters to the combinations of numeric or alpha numeric characters retrieved from a database, to form complete combinations. Subsequently, at step 312, the complete combinations of numeric or alpha numeric characters are validate to determine the status of each of the complete combinations. Further, at step 314, the complete combinations are communicated the user.

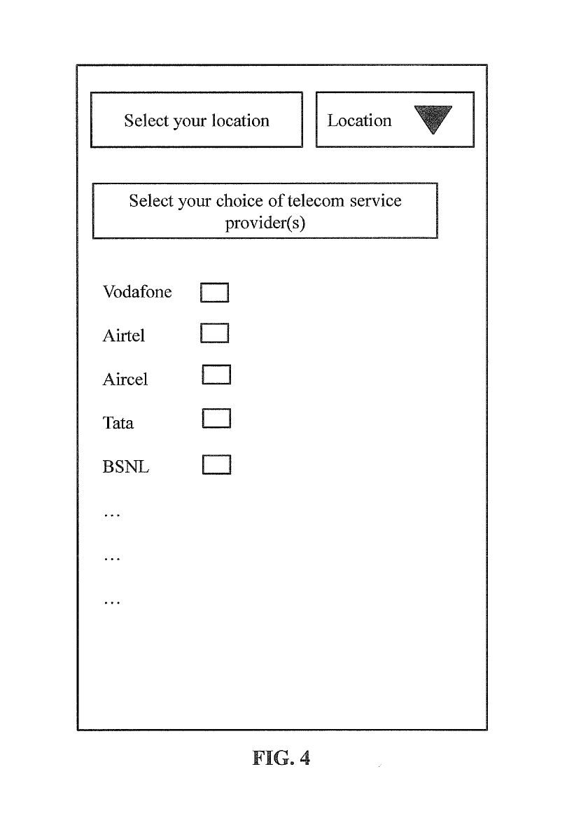

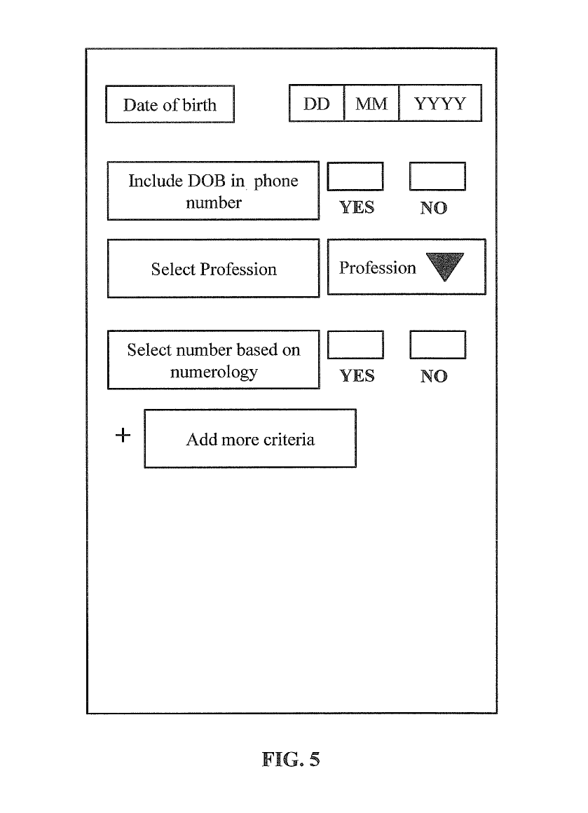

FIGS. 4 and 5 illustrate user interface to receive input from the user, wherein the system 100 is used to enable the user to select phone numbers, in accordance with an embodiment. In FIG. 4, the user provides input relating to the location (Ex: Delhi and Bangalore, among others) to which he wishes the telephone numbers should correspond to. Further, the user provides input relating to the telecom service provider to which he wishes the telephone numbers should correspond to. Further, in FIG. 5 the user provides inputs corresponding to his date of birth and other criteria for selecting the phone number.

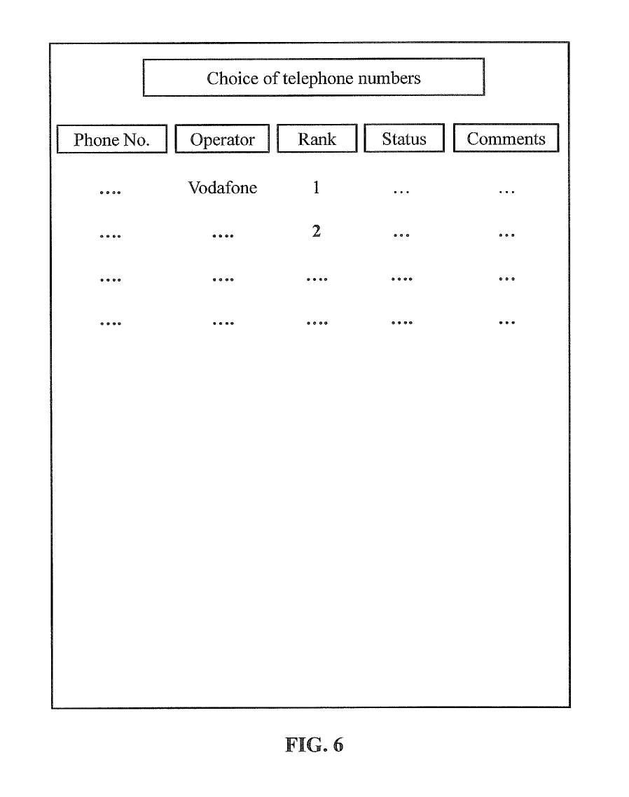

The system 100 processes the inputs and provides a list of phone numbers to choose from. FIG. 6 illustrates a user interface displaying a list of phone numbers, which the user can choose from, in accordance with an embodiment. In an embodiment, each of the numbers may be ranked based on the extent to which the phone number satisfies the considered criteria. Furthermore, the status (Ex: allotted or not allotted) of each of the telephone numbers displayed to the user is communicated to the user. Furthermore, relevance of each of the numbers with respect to the considered criteria, which may be derived from the rule engine 108, is communicated to the user.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling users to select combination of characters, the system comprising:
a database comprising a list of combinations of characters;
a system restriction module comprising instructions to select one or more combinations of characters present in the database, based on at least a part of input received from a user;
a rule engine comprising instructions to add combinations of characters to the one or more combinations of characters selected from the database, based on at least a part of input received from the user; and
a processing module configured to:
apply at least a part of the input received from the user to query the system restriction module and fetch corresponding instructions from the system restriction module;
apply at least a part of the input received from the user to query the rule engine and fetch corresponding instructions from the rule engine;
query the database based on the instructions fetched from the system restriction module;
generate complete combinations of characters based on the instructions fetched from the rule engine; and
communicate one or more generated complete combinations of characters to the user.

2. The system according to claim 1, wherein the characters are numeric or alpha numeric characters.

3. The system according to claim 1, wherein the complete combinations are telephone numbers.

4. The system according to claim 1, wherein the list of combinations of characters present in the database is a list of telephone number series.

5. The system according to claim 1, wherein the processing module is further configured to query the database based on the instructions fetched from the rule engine.

6. The system according to claim 1, wherein the processing module is further configured to check the availability status of the complete combinations of characters.

7. The system according to claim 6, wherein the processing module is further configured to communicate the status of the generated complete combinations of characters to the user.

8. The system according to claim 6, wherein the processing module is further configured to communicate only those generated complete combinations of characters to the user, which are available.

9. The system according to claim 1, wherein the processing module is further configured to rank the one or more generated complete combinations of characters, which are communicated to the user, wherein the ranking is based on the instructions fetched from the rule engine.
